(19) United States
(12) Patent Application Publication
(10) Pub. No.: US 2016/0122494 A1
(43) Pub. Date: May 5, 2016

(54) Foamed Plastic Material For Making Automobile Interior Parts And Manufacturing Method Thereof

(71) Applicant: San Yuan Design Co., Ltd., Taoyuan County (TW)

(72) Inventor: Ying-Chung Chen, Taoyuan County (TW)

(21) Appl. No.: 14/530,834

(22) Filed: Nov. 3, 2014

(51) Int. Cl. C08J 9/14; B29C 44/10

(52) U.S. Cl. CPC C08J 9/142; B29C 44/10; B29K 2033/04

(57) ABSTRACT

Disclosed is a foamed plastic material, particularly a foamed plastic material for making automobile interior parts, and a manufacturing method of the foamed plastic material. The foamed plastic material can be used in mass production by means of known injection molding processes and an automobile interior part manufactured with such a material shows a noble quality and a soft tactile impression similar to a manual surfacing material.

### BACKGROUND OF THE INVENTION

(a) Technical Field of the Invention

The present invention generally relates to a foamed plastic material, and more particularly to a foamed plastic material for making automobile interior parts and a method for manufacturing the foamed plastic material.

(b) Description of the Prior Art

Automobiles, which are now an indispensable transportation measure for modern living, are capable of conveniently and efficiently conveying people, animals, and goods to destinations. Progressively advancing with time, modems automobiles are no longer just an efficient transportation measure for people, people who use automobiles increasingly demand for bettered exterior appearance and interior decoration of automobiles for ensured driving safety and riding comfortableness and also a sign for social positions. Particularly, automobiles having expensive costs, such as automobile products of Benz and BMW) usually involve an exterior configuration of high degree of design and interior decorations of high quality.

In addition to seats, car interior generally include dashboards, interior partitions, interior door decoration panels, door handles, central armrests, and decoration bars. These car interior parts are required to be of excellent impact resistance, good temperature durability, no volatility, and no toxicity and are also required to show excellent visual quality and tactile impression in order to meet the dual requirements of safety and aesthetics for modern people. Generally, the automobile interior parts are made of plastic materials. This is because the plastic materials have parameters of high strength, high abrasion durability, high fatigue resistance, and high flexibility and has a weight that is less than steels and thus may save more fuel, making them suitable for applications in the automobile industry as a material for making automobile interior parts. Recently, the local automobile industry has been developed quickly and currently, the annual output of automobiles has exceeded a million pieces. Accordingly, the amount of plastics used to make the automobile interior parts each year has also been more than several hundred thousand tons.

Plastic materials that are commonly used to make the automobile interior parts include polypropylene (PP) resin and acrylonitrile-butadiene-styrene (ABS) resin. PP resin is a semicrystallized thermoplastic material having a melting point as high as 167° C. and a mechanical property of high impact resistance and toughness and being resistant to corrosion of a number of organic solvents and acids/alkalis and has wide applications in industries, making them a commonly used polymer material. ABS resin is a thermoplastic polymer material that has high strength and high flexibility, is resistant to corrosions of organic solvents and acids/alkalis, is easily processable and shapable and has a melting point of 175° C. for the ratio of acrylonitrile:butadiene:styrene being 20:30:50, making it a heat-resistant material. ABS resin can be mixed with various different resins to form a mixture, such as PC/ABS mixture, PVC/ABS mixture, and PBT/ABS mixture, producing various new properties and new fields of application.

Conventionally, these plastic materials of PP resin and ABS resin are added with blowing agents and other additives, such as coloring agents, to induce reactions that make foamed plastic materials having numerous tiny voids in the interior thereof. Such foamed plastic materials can be used to make automobile interior parts by plastic molding processes, such as injection molding, compression molding, and blow molding.

However, the automobile interior parts that are manufactured with foamed plastic materials made of PP resin and ABS resin does not provide excellent visual quality and tactile impression, making them not meet the high standards of high-end automobiles (such as Benz and BWM automobiles) to satisfy the customer's needs. Recently, the so-called power slush modeling technique has been proposed to improve the drawbacks of insufficient quality and lacking tactile impression of the automobile interior parts made of PP resin and/or ABS resin by injection molding. However, the powder slush modeling technique requires a model expenditure that is more than two times of that of the conventional injection molding and the equipment cost is astonishingly high. Thus, the automobile interior parts that are made with the powder slush modeling technique are expensive, making them not acceptable to general consumers. Another way of improving the conventional automobile interior parts made of PP resin and/or ABS resin is to manually surface the automobile interior parts. However, manually surfacing the automobile interior parts requires a large amount of labor and cost, and thus also makes the expenditure of automobile interior parts high, making it not meet the consumers' requirements for automobile interior parts that are of high quality but low cost.

Thus, it is desired to have a novel foamed plastic material suitable for automobile interior parts, where such a foamed plastic material can be used in the known injection molding machines so as to produce foamed plastic articles through injection molding in a mass-producing and cheap manner and the foamed plastic articles so manufactured possess a noble quality and soft tactile impression exactly the same as the surfacing materials.

### SUMMARY OF THE INVENTION

An object of the present invention is to provide a novel foamed plastic material that is suitable for automobile interior parts (such as a dashboard, an interior door decoration panel, a door handle, and a central armrest). The novel foamed plastic material can be used to replace the powder slush modeling technique that requires a high mold cost and can also be used to replace the manual surfacing operation that requires high labor cost so as to provide automobile interior parts that has a noble quality and soft tactile impression, are low cost, and allow for mass production.

The foamed plastic material for automobile interior parts according to the present invention possesses the following advantages: (1) having no toxicity and no volatility and resistance against temperature as high as 120° C.; (2) being injection-moldable in the conventional way and providing reliable and stable quality; (3) requiring low labor costs and having an increased throughput; (4) and providing similar quality and tactile impression compared to products of the same class (such as interiors of Benz C-class automobiles) but with a lower mold cost. Thus, the foamed plastic material of the present invention is extremely suitable for making interior parts of transportation devices (such as automobiles).

The object is achieved with the following technical solution of the present invention:

The present invention provides a foamed plastic material for making automobile interior parts, which comprises, based on weight percentage, thermoplastic polyether ester elastomer 60-80%, thermoplastic polystyrene elastomer 20-40%, blowing agent 5-10%, and color master batch 1-5%.

In a preferred embodiment of the present invention, the foamed plastic material for making automobile interior parts comprises, based on weight percentage, thermoplastic polyether ester elastomer 60-80%, thermoplastic polystyrene elastomer 20-40%; blowing agent 6%, and color master batch 2%.

In another preferred embodiment of the present invention, the foamed plastic material for making automobile interior parts comprises, based on weight percentage, Hytrel 30D 60-80%, AR-CS-15 20-40%; blowing agent 5-10%, and color master batch 1-5%.

In a further preferred embodiment of the present invention, the foamed plastic material for making automobile interior parts comprises, based on weight percentage, Hytrel 30D 60-80%, AR-CS-15 20-40%; blowing agent 6%, and color master batch 2%.

The present invention provides an automobile interior part made of a foamed plastic material. The foamed plastic material comprises, based on weight percentage, thermoplastic polyether ester elastomer 60-80%, thermoplastic polystyrene elastomer 20-40%; blowing agent 5-10%, and color master batch 1-5%.

The present invention also provides an automobile interior part made of a foamed plastic material. The foamed plastic material comprises, based on weight percentage, thermoplastic polyether ester elastomer 60-80%, thermoplastic polystyrene elastomer 20-40%; blowing agent 6%, and color master batch 2%.

The present invention further provides an automobile interior part made of a foamed plastic material. The foamed plastic material comprises, based on weight percentage, Hytrel 30D 60-80%, AR-CS-15 20-40%; blowing agent 5-10%, and color master batch 1-5%.

The present invention further provides an automobile interior part made of a foamed plastic material. The foamed plastic material comprises, based on weight percentage, Hytrel 30D 60-80%, AR-CS-15 20-40%; blowing agent 6%, and color master batch 2%.

The present invention also provides a manufacturing method of a foamed plastic material for making automobile interior parts, in which all figures of percentage are weight percentages and the weight percentage of the finally-produced foamed plastic material is 100%, comprising the following steps: (1) weighing particles of Hytrel 30D for a percentage of 60-80% and baking at 90 degrees Celsius for two hours; (2) weighing particles of AR-CS-15 for 20-40%, blowing agent for 6%, and color master batch for 2%; (3) uniformly mixing the baked Hytrel 30D particles, the AR-CS-15 particles, the blowing agent, and the color master batch to provide a mixture; (4) placing the mixture of step (3) in an injection molding machine to have the mixture melting into a liquid state at 185 degree Celsius; (5) operating the injection molding machine to inject the liquid mixture of step (4) into a mold and keeping the mold constantly pressurized to make the liquid mixture completely fill up the mold; (6) allowing the liquid mixture that completely fills up the mold in step (5) to cool down together with the mold and cured at 45 degree Celsius; and (7) removing the cured object of step (6) to obtain the foamed plastic material.

The foregoing objectives and summary provide only a brief introduction to the present invention. To fully appreciate these and other objects of the present invention as well as the invention itself, all of which will become apparent to those skilled in the art, the following detailed description of the invention and the claims are provided.

Many other advantages and features of the present invention will become manifest to those versed in the art upon making reference to the detailed description in which preferred embodiments incorporating the principles of the present invention are shown by way of illustrative example.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a foamed plastic material for making automobile interior parts, which comprises the following ingredients: (A) thermoplastic polyether ester elastomer (TPEE), (B) thermoplastic polystyrene elastomer (TPS); (C) blowing agent, and (D) color master batch.

Thermoplastic polyether ester elastomer (TPEE) contained in the foamed plastic material according to the present invention, which is also referred to as “polyester rubber”, is a linear block copolymer formed collectively of a hard segment of polybutylene terephthalate (PBT) and a soft segment of aliphatic polyester or polyether. Compared to rubbers, TPEE has better processability and extended lifespan. Compared to engineering plastics, TPEE possesses the same strength but also has better flexibility and mechanic property. Thus, TPEE simultaneously the excellent elasticity of rubbers and the good processability of thermoplastic plastic materials, making it an excellent and widely-used thermoplastic elastomer.

Thermoplastic polyether ester elastomer (TPEE) used in the foamed plastic material according to the present invention is preferably a thermoplastic polyether ester elastomer produced by Du Pont company, USA, with a trade name of Hytrel and is more preferably a thermoplastic polyether ester elastomer of Hytrel having Shore Durometer 30D, which is referred to as Hytrel 30D). Further, the ratio of thermoplastic polyether ester elastomer contained in the foamed plastic material of the present invention, based on weight percentage, is preferably 50-90%, more preferably 55-85%, and even more preferably 60-80%.

Thermoplastic polystyrene elastomer (TPS) contained in the foamed plastic material according to the present invention can be classified in two groups: block copolymer of polystyrene and rubber (polybutadiene and polyisoprene) and a mixture produced, with the copolymer being a base, through mixing and co-producing with polyolefin and plasticizer. In the block copolymer of polystyrene and rubber, the molecule hard segment is polystyrene and the molecule soft segment is polybutadiene or polyisoprene.

Representative commercial products of TPS are styrene-butadiene-styrene (SBS) block copolymer, styrene-isoprene-styrene (SIS) block copolymer, styrene-ethylene-butene-styrene (SEBS) block copolymer, and styrene-ethylene-propylene-styrene (SEPS) block copolymer TPS has low rigidity, high elongation, ad good resiliency, and, compared to other thermoplastic elastomer, is relatively soft, easy to stretch, and easy to process, and provides a tactile impression similar to rubbers.

Thermoplastic polystyrene elastomer (TPS) used in the foamed plastic material according to the present invention is preferably a thermoplastic polystyrene elastomer produced by Aronkasei Co., Ltd., Japan, having a part number of AR-CS-15. Further, the ratio of thermoplastic polystyrene elastomer contained in the foamed plastic material of the present invention, based on weight percentage, is preferably 10-50%, more preferably 15-45%, and even more preferably 20-40%.

The ratio between (A) thermoplastic polyether ester elastomer (TPEE) and (B) thermoplastic polystyrene elastomer (TPS) of the foamed plastic material of the present invention is adjustable according to the needs of the manufacturers. Generally, the ratio between thermoplastic polyether ester elastomer (TPEE) and thermoplastic polystyrene elastomer (TPS) is set between 1:1 to 9:1 and preferably between 4:1 to 3:2.

The blowing agent contained in the foamed plastic material according to the present invention is a class of agents that is added in a polymer to release gases during a process of operation so as to form tiny voids in the polymer material and can be classified as physical blowing agents and chemical blowing agents. The commonly used physical blowing agents include air, nitrogen gas, carbon dioxide, hydrocarbons, and Freon. The chemical blowing agents refer to a substance that, when heated, releases gases, such as nitrogen gas and carbon dioxide. The commonly used chemical blowing agents include sodium bicarbonate, ammonium carbonate, and azodicarbonamide. Further, the ratio of the blowing agent contained in the foamed plastic material of the present invention, based on weigh percentage, is preferably 5-10%, and more preferably 5-7%, and even more preferably 6%.

The color master batch contained in the foamed plastic material according to the present invention, which is also referred to as coloring seed, is a novel coloring agent specifically for polymer materials and is primarily used for coloring plastics. The color master batch is composed of two essential ingredients of pigment and carrier. The pigments used in color master batch are generally classified as organic pigments and inorganic pigments. The commonly used organic pigments include quinacridone red, phthalocyanine blue, phthalocyanine green, and azo red. The commonly used inorganic pigments include cadmium red, cadmium yellow, titanium white, and carbon black. Color master batch often uses resin as a carrier. Further, the ratio of the color master batch contained in the foamed plastic material of the present invention, based on weigh percentage, is preferably 1-5%, and more preferably 1-3%, and even more preferably 2%.

A table is given below to list a preferred composition of the foamed plastic material of the present invention and the best ratio of the ingredients thereof:

| Item | Ingredient | Ratio (Weight Percentage) |
|---|---|---|
| A | Hytrel 30D | 60-80% |
| B | AR-CD-15 | 20-40% |
| C | Blowing Agent | 6% |
| D | Color Master Batch | 2% |

An illustrative example will be given as follows to further describe the present invention.

Particles of Hytrel 30D (available from Du Pont Company, USA) are weighed for 1750 grams. The particles of Hytrel 30D are then baked with a baking machine at a temperature of 90° C. for two hours in order to remove the moisture of the Hytrel 30D particles. Particles of AR-SC-15 (available from Aronkasei Co., Ltd., Japan) are weighed for 750 grams. A blowing agent, MBF-190EVA50 (which is a copolymer of ethylene-vinyl acetate available from Matsumoto Yushi-Seiyaku Co., Ltd., Japan), is weighed for 150 gram. And, a color master batch specifically for use in plastic injection molding, product code number UN2014, (available from Cabot Company, USA) is weighed for 50 grams.

Hytrel 30D that is obtained above with moisture removed is mixed with AR-CS-15, MBF-190EVA50, and UN2014 in a mixing machine to finally provide a material mixture that maintains a state of solid particles.

The mixed solid particles are fed into a hopper of a plastic injection molding machine and the mixed solid particles uniformly melt into a liquid state under a temperature of 185° C. in a material barrel. Afterwards, under the parameter conditions that injection pressure is set at 45 kg/cm² and injection speed is set as 35 cm³/sec, the liquid mixture is injected through a mold filling port into a mold.

The liquid mixture is continuously filled into the mold and is pressured, under the pressure of 30 kg/cm2 and speed of 13 cm3/sec, in the plastic injection molding machine for seconds to fill up the mold. The liquid mixture that fills up the mold is then allowed to cool down, together with the mold, to a temperature of 45° C. and is kept still for minutes to allow the injected mixture to gradually foam and cool down and cure. Finally, the mold is opened and the cooled and cured foamed plastic object is removed thereby obtain a desired automobile interior part.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A foamed plastic material for making automobile interior parts, comprising, based on weight percentage:
thermoplastic polyether ester elastomer 60-80%;
thermoplastic polystyrene elastomer 20-40%;
blowing agent 5-10%, and
color master batch 1-5%.

2. The foamed plastic material for making automobile interior parts according to claim 1, wherein the blowing agent is 6% and the color master batch is 2%.

3. The foamed plastic material for making automobile interior parts according to claim 1, wherein the thermoplastic polyether ester elastomer comprises Hytrel 30D and the thermoplastic polystyrene elastomer comprises AR-CS-15.

4. The foamed plastic material for making automobile interior parts according to claim 2, wherein the thermoplastic polyether ester elastomer comprises Hytrel 30D and the thermoplastic polystyrene elastomer comprises AR-CS-15.

5. An automobile interior part, which is made of the foamed plastic material according to claim 1.

6. An automobile interior part, which is made of the foamed plastic material according to claim 2.

7. An automobile interior part, which is made of the foamed plastic material according to claim 3.

8. An automobile interior part, which is made of the foamed plastic material according to claim 4.

9. The automobile interior part according to claim 8, which comprises one of a dashboard, an interior partition board, an interior door decoration panel, an automobile door handle, a central armrest, and a decoration strip.

10. A manufacturing method of a foamed plastic material for making automobile interior parts, comprising the following steps, in which all figures of percentage are weight percentages and the weight percentage of the finally-produced foamed plastic material is 100%:
(1) weighing particles of Hytrel 30D for 60-80% and baking at 90 degrees Celsius for two hours;
(2) weighing particles of AR-CS-15 for 20-40%, blowing agent for 6%, and color master batch for 2%;
(3) uniformly mixing the baked Hytrel 30D particles, the AR-CS-15 particles, the blowing agent, and the color master batch to provide a mixture;
(4) placing the mixture of step (3) in an injection molding machine to have the mixture melting into a liquid state at 185 degree Celsius;
(5) operating the injection molding machine to inject the liquid mixture of step (4) into a mold and keeping the mold constantly pressurized to make the liquid mixture completely fill up the mold;
(6) allowing the liquid mixture that completely fills up the mold in step (5) to cool down together with the mold and cured at 45 degree Celsius; and
(7) removing the cured object of step (6) to obtain the foamed plastic material.
